(19) United States
(12) Patent Application Publication
(10) Pub. No.: US 2012/0118987 A1
(43) Pub. Date: May 17, 2012

(54) THERMOSTAT ASSEMBLY

(75) Inventor: Shai BRENNER, Haifa (IL)

(73) Assignee: FISHMAN THERMO TECHNOLOGIES LTD., Misgav (IL)

(21) Appl. No.: 13/290,524

(22) Filed: Nov. 7, 2011

Related U.S. Application Data
(60) Provisional application No. 61/412,408, filed on Nov. 11, 2010.

(51) Int. Cl. G05D 23/02; F16K 31/70

(52) U.S. Cl. 236/93 R; 137/468

(57) ABSTRACT

A thermostat assembly for controlling a flow of a fluid through an aperture, the thermostat assembly comprising: a displaceable valve for controlling the opening and closing of the aperture; a flange and a lower bridge, both configured for securing said displaceable valve in place; a flexible member positioned between said lower bridge and said displaceable valve; wherein said lower bridge comprises a locking mechanism integrally formed therein and configured to lock said displaceable valve in a position where said aperture is open.

### CROSS REFERENCE TO RELATED APPLICATIONS

This application claims the benefit of U.S. Provisional Patent Application No. 61/412,408, filed Nov. 11, 2010 and entitled “Thermostat Assembly”, which is incorporated herein by reference in its entirety.

### FIELD

Embodiments of the disclosure relate to a thermostat assembly for controlling a flow of a fluid through an aperture.

### BACKGROUND

A thermostat is often defined as a device for regulating the temperature of a system and maintaining it within a desired range. Commonly, the thermostat achieves this by switching heating or cooling devices on or off, or regulating the flow of a coolant fluid.

Thermostats commonly serve as control units for heating or cooling systems, components of air conditioner and the like. Thermostats may be constructed in many ways and may use a variety of sensors or temperature-sensitive materials to measure the temperature or act upon it.

Mechanical thermostats are widely used in the internal combustion engine cooling mechanisms. These thermostats often use a temperature sensitive valve to control the opening of the thermostat's aperture and maintain the core temperature of the engine at its optimum by regulating the flow of a coolant fluid to an external heat sink, usually a radiator.

While the thermostat is closed, there is no flow of coolant in the loop allowing the combustion chambers to warm up rapidly. The thermostat stays closed until the coolant temperature reaches the nominal thermostat opening temperature. The thermostat then progressively opens as the coolant temperature increases to the optimum operating temperature, increasing the coolant flow to the radiator. Once the optimum operating temperature is reached, the thermostat progressively increases or decreases its opening in response to temperature changes, dynamically balancing the coolant recirculation flow and coolant flow to the radiator to maintain the engine temperature in the optimum range as engine heat output, vehicle speed, and outside ambient temperature change.

### SUMMARY

The following embodiments and aspects thereof are described and illustrated in conjunction with systems, tools and methods which are meant to be exemplary and illustrative, not limiting in scope.

An aspect of some embodiments relates to a thermostat assembly comprising an advantageous locking element.

Generally, the thermostat assembly includes a displaceable valve for controlling the opening and closing of an aperture of the thermostat assembly, respective to the surrounding temperature. The displaceable valve may be secured in place using an upper bridge and a lower bridge. A flexible member, such as a spring, may be located between the lower bridge and the displaceable valve to keep the aperture of the thermostat assembly normally closed.

Advantageously, the lower bridge includes an integrally formed locking element, shaped as one or more teeth bent inwards.

The valve is displaceable along a certain range, which may be divided into a normal working range and a high-risk range. In the high-risk range, there is an increased risk of damage to one or more of the valve's inner components, which may cause inappropriate opening and/or closure of the aperture. The ultimate risk is that, as a result of damage to the valve, it will fail to open the aperture sufficiently, and therefore prevent sufficient flow of cooling liquid. This may then lead to damage to the system being cooled. Therefore, the locking element is configured such that it locks the valve in an open position when it exceeds the working range and enters the high-risk range, so that the situation where the valve fails and does not allow sufficient flow is prevented.

The advantageous locking element, which is integrally formed with the lower bridge, adds an important feature to the thermostat assembly without adding more parts which may move, become damaged or the like during assembly or operation.

An additional issue is the need for one-direction flexibility of the locking element; the locking element has to be flexible when it lets the displaceable valve pass it and enter the high-risk range, but inflexible when it blocks the displaceable valve from retracting back to its working range.

There is provided, in accordance with an embodiment, a thermostat assembly for controlling a flow of a fluid through an aperture, the thermostat assembly comprising: a displaceable valve for controlling the opening and closing of the aperture; a flange and a lower bridge, both configured for securing said displaceable valve in place; a flexible member positioned between said lower bridge and said displaceable valve; wherein said lower bridge comprises a locking mechanism integrally formed therein and configured to lock said displaceable valve in a position where said aperture is open.

In some embodiments, said locking element comprises at least one leaf bent inwards.

In some embodiments, said displaceable valve comprises a disc configured for physically closing said aperture.

In some embodiments, said displaceable valve comprising a thermal sensitive material.

In some embodiments, said displaceable valve comprising a displaceable pin.

In some embodiments, said displaceable valve is configured to extend according to the surrounding temperature.

In some embodiments, said flange further comprises a jog pin configured for providing pressure relief of said thermostat assembly.

In some embodiments, said lower bridge further comprising one or more connectors and said upper bridge further comprising one or more sockets matching said one or more connectors.

There is further provided, in accordance with an embodiment, an integrated lock-support mechanism for a thermostat, the mechanism comprising a body having a base and at least two lateral arms, said base comprising an aperture configured to accommodate a displaceable valve of the thermostat, and said lateral arms each comprising a locking leaf configured to lock the thermostat in a locked position upon exceeding a predetermined displacement range.

In some embodiments, each of said lateral arms further comprises an additional locking leaf for enhancing the locking.

In some embodiments, each of said locking leaves is bent inwards.

In some embodiments, each of said locking leaves is configured to bend outwards responsive to displacement of the displaceable valve.

In some embodiments, each of said lateral arms further comprises one or more connectors configured to match one or more sockets of a flange of the thermostat.

In some embodiments, said integrated lock-support mechanism, further comprising: a displaceable valve for controlling the opening and closing of a fluid aperture of the thermostat; a flange configured, together with the integrated lock-support mechanism, for supporting said displaceable valve in place; and a flexible member positioned between said base and the displaceable valve.

In some embodiments, each of said locking leaves is bent inwards.

In some embodiments, said displaceable valve comprises a disc configured for physically closing said fluid aperture.

In some embodiments, said displaceable valve comprises a thermal sensitive material for causing said displaceable valve to extend according to the surrounding temperature.

In some embodiments, said displaceable valve further comprises a displaceable pin.

In some embodiments, each of said lateral arms further comprises one or more connectors, and said flange comprises one or more sockets matching said one or more connectors.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A shows an upper perspective view of a thermostat assembly;

FIG. 1B shows a lower perspective view of the thermostat assembly;

FIG. 2 shows a perspective view of a lower bridge of the thermostat assembly;

FIG. 3A shows a cross sectional view of the thermostat assembly with a displaceable valve situated in a closed position;

FIG. 3B shows a cross sectional view of the thermostat assembly with the displaceable valve situated in an open position;

FIG. 3C shows a cross sectional view of the thermostat assembly with the displaceable valve situated in a locked position; and

FIG. 4 shows a diagram of valve disk displacement relative to temperature.

### DETAILED DESCRIPTION

An aspect of some embodiments relates to a thermostat assembly comprising an advantageous locking mechanism, which is integrally formed with a lower bridge of the assembly.

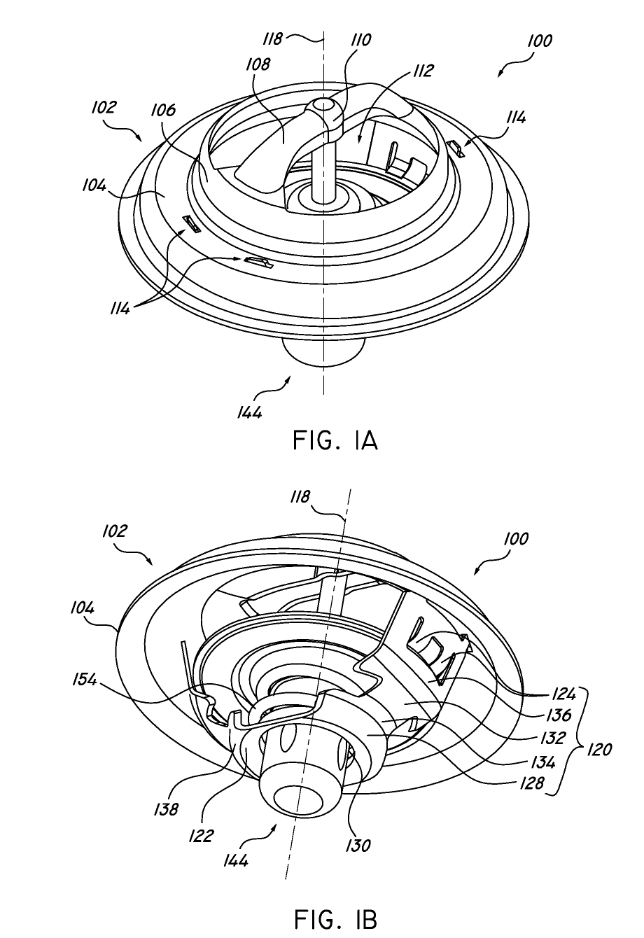

Reference is now made to FIGS. 1A and 1B, which show a thermostat assembly 100 in upper and lower perspective views, respectively, according to an embodiment. Thermostat assembly 100 advantageously includes an integrally-formed locking mechanism, shaped as one or more locking leaves 124 integrated into a lower bridge 120.

Thermostat assembly 100 may be adapted to operate in a fluid environment; the thermostat is configured to respond to temperature variations and to control the fluid flow by closing and opening an aperture 112 accordingly.

As schematically shown, thermostat assembly 100 may include a displaceable valve 144 as well as a flange 102 and a lower bridge 120, the latter two being configured to provide the valve with structural support; while the flange delimits the valve from the top, the lower bridge defines the valve's motion track from the bottom, optionally with the assistance of a flexible member such as a spring 154.

Flange 102 may include a flange disk 104 having at least two flange sockets 114. Flange disk 104 surrounds an optionaly flange ring 106 which is generally disposed perpendicular to it, forming a substantially circular aperture 112.

Flange 102 may further include an upper bridge 108, formed as an arc optionally having a pin niche 110 suitable for accommodating a valve pin, which is further discussed below. Upper bridge 108 may be connected to, attached to or integrally formed with flange ring 106 at its edges and may optionally have a convex cross-section.

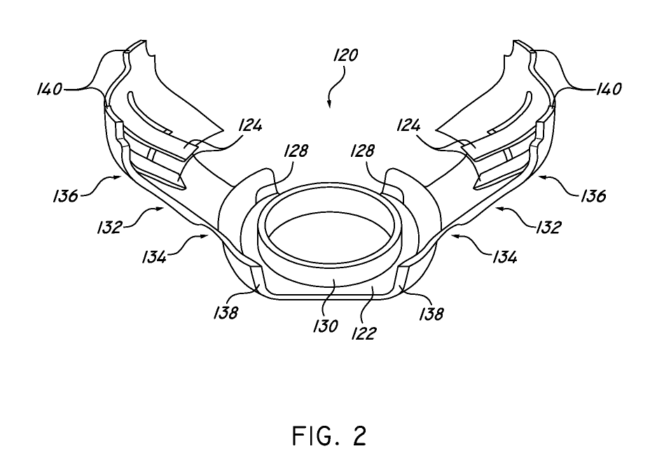

Reference is now made to FIG. 2, which shows lower bridge 120 in more detail. For ease of comprehension, reference numerals in FIG. 2 match those appearing in FIGS. 1A-B, and some of the features of lower bridge 120 may be seen both in FIGS. 1A-B and in FIG. 2. As schematically shown, lower bridge 120 includes a base 122 formed as a circumferential plate having, for example, two opposing lower bridge round edges 128. Base 122 borders with an elevated lower bridge ring 130 forming an optionally circular aperture located in the center of the base, and having a diameter large enough to accommodate a valve body, which is further discussed below.

Two arm bases 138, shaped, for example, as bent panels, may be perpendicularly adjacent, with their longer edge, to lower bridge rounded edges 128.

Two arms 132 may be shaped as elongated plates extending from arm bases 138, and optionally having a narrow arm lower end 134 and a wide arm upper end 136. Arms 132 may be bent outwards and form obtuse angles with base 122.

Lower bridge 120 may further include, at each of wide arm upper ends 136, one or more connectors 140 which are formed as localized extensions of the upper ends, and being matching to one or more flange sockets 114 of FIGS. 1A-B. Connectors 140 may be used to secure lower bridge 120 to flange 102 of FIGS. 1A-B.

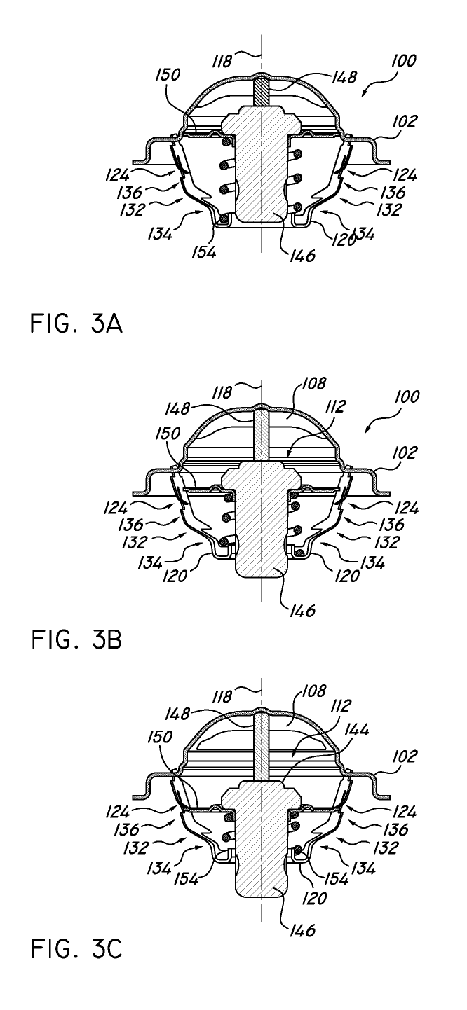

Reference is now made to FIGS. 3A, 3B and 3C, which show cross-sectional views of thermostat assembly 100 of FIGS. 1A-B, with its displaceable valve 144 situated in different positions.

Displaceable valve 144 may be located between flange 102 and lower bridge 120, and being displaceable along a main axis 118. Displaceable valve 144 may have a cylindrical valve body 146 accommodating a valve pin 148 and containing a thermal sensitive material.

The displaceable valve 144 further includes a valve disk 150 connected to, attached to or integrally formed with valve body 146, and used for physically closing aperture 112 of FIGS. 1A-B, by pressing against flange disk 104 of FIGS. 1A-B. Optionally, thermostat assembly 100 includes one or more gaskets (not shown) disposed on valve disk 150 and/or on flange disk 104 of FIGS. 1A-B, in order to improve the sealing of aperture 112.

Valve pin 148 is at least partially located within valve body 146, having one of its ends laid within the thermal sensitive material and the other end protruding, at least in operation, from valve body 146 and pushing against upper bridge 108 and/or pin niche 110 of the upper bridge. Valve pin 148 may or may not be secured to pin niche 110.

The thermal sensitive material in valve body 146 may be adapted to respond to temperature variations and displace valve pin 148 along main axis 118, so that it presses against upper bridge 108 and/or pin niche 110 of the upper bridge. The higher the temperature, the harder valve pin 148 presses.

Spring 154, which is shown as an example of a flexible member, may be located between valve disk 150 and lower bridge 120, and be configured to normally contract displaceable valve 144 and drive valve disk 150 along main axis 118 towards closing the aperture 112. These opposite forces applied on the valve pin 148 constantly aspire to reach equilibrium and consequently place the displaceable valve 144 in the right position and open or close the aperture 112 accordingly.

Reference is now made back to FIG. 1A. In some scenarios, such as when a liquid coolant gets heated very quickly, pressure differences may build up under displaceable valve 144. The pressure differences between the area below displaceable valve 144 and above it can make it difficult (or even impossible) for valve pin 148 to push displaceable valve 144 and open the aperture 112. Consequently, this may interfere with the thermostat's normal operation. Therefore, an optional pressure discharge valve, such as a jog pin 116, is embedded into flange disk 104 and set to relief pressure differences beyond a certain threshold.

Reference is now made back to FIGS. 1A-B. The displaceable valve 144 is configured to be displaced within a certain vertical range, which may be divided, for the purpose of the discussion, into a normal working range and a high-risk range. Overheating and/or malfunction may cause displaceable valve 144 to extend beyond the working range and reach into the high-risk range. The high-risk range involves a high risk of permanent damage to one or more of displaceable valve's 144 inner components, which may, in turn, cause inappropriate opening and/or closure of the aperture 112.

Once displaceable valve 144 is damaged, one or more malfunctions may occur. One possible malfunction may cause the thermal sensitive material not to apply the appropriate force to extract the desired portion of valve pin 148 out of valve body 146. The extraction force applied by the thermal sensitive material may not be sufficient to overcome the opposite force applied by spring 154. The valve pin will not be able push the valve disk away from aperture 112 and, consequently, the aperture will remain closed or at least not sufficiently open.

Therefore, using a conventional thermostat involves a risk of running into a “fail-closed” scenario in which the thermostat assembly 100 becomes damaged and the displaceable valve 144 is unable to open the aperture 112 and therefore does not enable the thermostat assembly 100 to dispose the hosting system's excessive heat, and consequently cause heavy damages to the hosting system.

Having a locking mechanism integrated into thermostat assembly 100 has the advantage of preventing thermostat assembly 100 from getting into such a “fail-close” scenario. Once displaceable valve 144 displaces beyond the working range and reaches the locking range, locking leaves 124 lock the displaceable valve in position and prevent it from retracting back into the working range. This, essentially, locks thermostat assembly 100 in an open position before thermostat assembly 100 becomes damaged.

As schematically shown in FIG. 2, lower bridge 120 advantageously includes at least two locking leaves 124, each integrally formed as a flexible tab partially cut of the lower bridge and bent inwards, into the path of valve disk 150. Those of skill in the art will recognize that a locking leaf may have any suitable structural that is adapted to lock the valve and prevent it from returning to its normally closed position once it reaches beyond certain displacement; locking leaves 124 are shown as flexible tabs merely as one example.

Reference is now made back to FIGS. 3A, 3B and 3C. As mentioned, locking leafs 124 may be bent inwardly such that an open edge of each of the leaves crosses the path of displaceable valve 144. The position of the open edges of locking leafs 124 determines the beginning of valve disk's 150 locking range. As the edge of valve disk 150 reaches the edge of locking leaf 124, the locking leaf is pushed outwardly and allows the displaceable valve 144 to pass and enter the locking range. Once the edge of valve disk 150 passes locking leaf 124, the locking leaf returns to its original position and prevents displaceable valve 144 from returning back into its normal working range and, consequently, locks the displaceable valve in an open position.

As schematically shown in FIG. 3A, thermostat assembly 100 has its displaceable valve 144 is in an open position. The thermal sensitive material applies a force greater than the force applied by spring 154 in the closed position; this causes the extraction of a greater portion of valve pin 148 out of valve body 146, towards upper bridge 108. The extraction force applied by the thermal sensitive material is sufficient to overcome the opposite force of the flexible member 154 and push the valve disk 150 away from the aperture and, consequently, aperture 112 opens.

FIG. 3B shows thermostat assembly 100 with displaceable valve 144 in a closed position. The thermal sensitive material applies a force that extracts a portion of valve pin 148 out of valve body 146 towards the upper bridge 108, but this extraction force is not sufficient to overcome the opposite force of spring 154. Consequently, aperture 112 closes.

FIG. 3C shows thermostat assembly 100 with the displaceable valve 144 in a locked position. The thermal sensitive material applies a force greater than the force applied in the open position, which force extracts a greater portion of valve pin 148 out of valve body 146, towards upper bridge 108. The extraction force applied by the thermal sensitive material is sufficient to overcome the opposite force of spring 154 and push valve disk 150 away from aperture 112. Valve disk 150 reaches beyond the edge of locking leaf 124 and, consequently, displaceable valve 144 becomes locked in the locked position and aperture 112 remains permanently open.

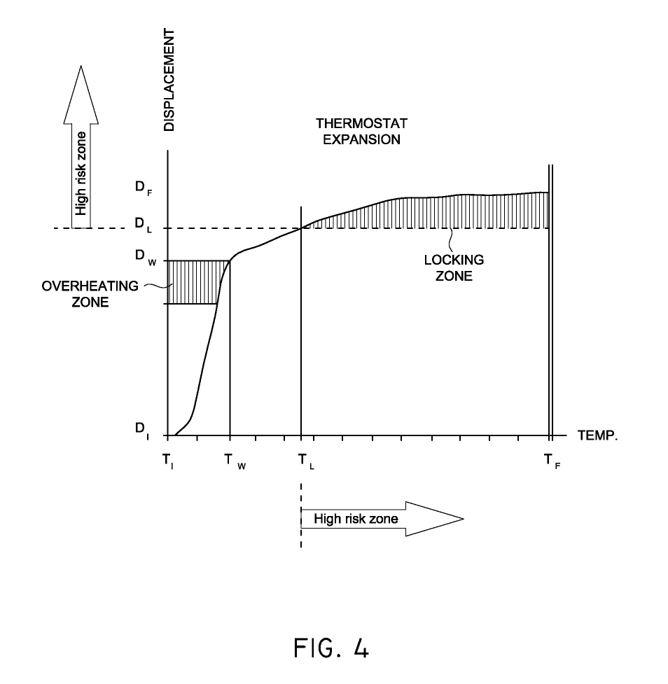

FIG. 4 shows a diagram of the displacement length of valve disk 150 (and, essentially, that of displaceable valve 144) of the previous figures, relative to changes in temperature. As shown, the displaceable valve is displaced under normal working conditions from its initial position Dᵢ at initial temperature Tᵢ, up to a distance D_{w} at a maximum normal working temperature T_{w}. The range between temperatures Tᵢ and T_{w} is the normal working zone of the thermostat and will vary according to the design characteristics of the thermostat.

As the temperature exceeds T_{w}, the valve disk is further displaced, and then reaches the pre-determined locking distance D_{L} at the pre-determined extreme temperature T_{L}. The range between temperatures T_{w} and T_{L} is an overheating buffer zone for the thermostat. While the temperatures in this zone exceed the normal working temperatures of the thermostat, they are not considered to be high enough that permanent damage is likely to occur to either the hosting system, or the thermostat assembly itself. At the pre-determined extreme temperature T_{L} the thermostat is being subjected to extreme overheating and at this point there may be a risk of damage to the thermostat and to the hosting system. Further increases in temperature above the pre-determined temperature T_{L} cause a further displacement of the valve disk up to a failure distance D_{f} where a failure temperature T_{f} is reached. At this point, the internal components of the displaceable valve will probably fail. For conventional thermostats, failure typically occurs at temperature T_{f}. When the thermostat has failed, the valve pin may no longer act to force the valve disk axially away from the upper bridge and, consequently, the flexible member drives the valve disk towards closing the aperture. However, since the valve disk has been displaced beyond the pre-determined distance D_{L}, the locking leaf prevents it from returning to the closed position. The pre-determined locking distance D_{L} is thus set between the maximum normal working distance D_{w} and the failure distance D_{f}. The overheating buffer zone is provided to account for minor, non-detrimental, temperature increases above the working zone. However, once D_{L} has been reached, the locking leaf will engage the displaceable valve to prevent the valve disk from returning to the closed position.

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

In the claims description of the application, each of the words “comprise” “include” and “have”, and forms thereof, are not necessarily limited to members in a list with which the words may be associated.

What is claimed is:

1. A thermostat assembly for controlling a flow of a fluid through an aperture, the thermostat assembly comprising:
a displaceable valve for controlling the opening and closing of the aperture;
a flange and a lower bridge, both configured for securing said displaceable valve in place; and
a flexible member positioned between said lower bridge and said displaceable valve,
wherein said lower bridge comprises a locking mechanism integrally formed therein and configured to lock said displaceable valve in a position where said aperture is open.

2. The thermostat assembly according to claim 1, wherein said locking mechanism comprises at least one leaf bent inwards.

3. The thermostat assembly according to claim 1, wherein said displaceable valve comprises a disc configured for physically closing said aperture.

4. The thermostat assembly according to claim 1, wherein said displaceable valve comprising a thermal sensitive material.

5. The thermostat assembly according to claim 1, wherein said displaceable valve comprising a displaceable pin.

6. The thermostat assembly according to claim 1, wherein said displaceable valve is configured to extend according to the surrounding temperature.

7. The thermostat assembly according to claim 1, wherein said flange further comprises a jog pin configured for providing pressure relief of said thermostat assembly.

8. The thermostat assembly according to claim 1, wherein said lower bridge further comprising one or more connectors and said upper bridge further comprising one or more sockets matching said one or more connectors.

9. An integrated lock-support mechanism for a thermostat, the mechanism comprising a body having a base and at least two lateral arms, said base comprising a ring configured to accommodate a displaceable valve of the thermostat, and said lateral arms each comprises a locking leaf configured to lock the thermostat in a locked position upon exceeding a predetermined displacement range.

10. The integrated lock-support mechanism according to claim 9, wherein each of said lateral arms further comprises an additional locking leaf for enhancing the locking.

11. The integrated lock-support mechanism according to claim 9, wherein each of said locking leaves is bent inwards.

12. The integrated lock-support mechanism according to claim 9, wherein each of said locking leaves is configured to bend outwards responsive to displacement of the displaceable valve.

13. The integrated lock-support mechanism according to claim 9, wherein each of said lateral arms further comprises one or more connectors configured to match one or more sockets of a flange of the thermostat.

14. The integrated lock-support mechanism according to claim 9, further comprising:
a displaceable valve for controlling the opening and closing of a fluid aperture of the thermostat;
a flange configured, together with the integrated lock-support mechanism, for supporting said displaceable valve in place; and
a flexible member positioned between said base and the displaceable valve.

15. The integrated lock-support mechanism according to claim 14, wherein each of said locking leaves is bent inwards.

16. The integrated lock-support mechanism according to claim 14, wherein said displaceable valve comprises a disc configured for physically closing said fluid aperture.

17. The integrated lock-support mechanism according to claim 14, wherein said displaceable valve comprises a thermal sensitive material for causing said displaceable valve to extend according to the surrounding temperature.

18. The integrated lock-support mechanism according to claim 17, wherein said displaceable valve further comprises a displaceable pin.

19. The integrated lock-support mechanism according to claim 14, wherein each of said lateral arms further comprises one or more connectors, and said flange comprises one or more sockets matching said one or more connectors.
